(19) United States
(12) Patent Application Publication
(10) Pub. No.: US 2009/0237606 A1
(43) Pub. Date: Sep. 24, 2009

(54) LIQUID CRYSTAL DISPLAY DEVICE

(76) Inventors: Toshiyuki HIGANO, Ishikawa-gun (JP); Kenji NAKAO, Kanazawa-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/396,666

(22) Filed: Mar. 3, 2009

(30) Foreign Application Priority Data
Mar. 19, 2008 (JP) 2008-072443

(51) Int. Cl. G02F 1/1343

(52) U.S. Cl. 349/139

(57) ABSTRACT

A liquid crystal display device is configured such that a liquid crystal layer is held between an array first substrate and a counter-substrate. The array substrate includes a pixel electrode which is disposed in association with each of pixels in a display region which displays an image, and a counter-electrode which is opposed to the pixel electrode with a distance therebetween. The counter-substrate includes an insulating substrate, and a shield electrode which is disposed between the liquid crystal layer and the insulating substrate over an entirety of the display region. The liquid crystal layer is formed of a liquid crystal material having a negative dielectric constant anisotropy.

### CROSS-REFERENCE TO RELATED APPLICATIONS

This application is based upon and claims the benefit of priority from prior Japanese Patent Application No. 2008-072443, filed Mar. 19, 2008, the entire contents of which are incorporated herein by reference.

### BACKGROUND OF THE INVENTION

1. Field of the Invention

The present invention relates generally to a liquid crystal display device, and more particularly to a liquid crystal display device which is configured to have a pixel electrode and a counter-electrode on one of substrates that constitute a liquid crystal display panel.

2. Description of the Related Art

In recent years, flat-panel display devices, which take the place of CRT displays, have vigorously been developed, and liquid crystal display device have attracted particular attention because of their advantages of light weight, small thickness and low power consumption. In particular, in an active matrix liquid crystal display device in which a switching element is provided in each of pixels, attention has been paid to the structure which makes use of a transverse electric field (including a fringe electric field), such as IPS (In-Plane Switching) mode and an FFS (Fringe Field Switching) mode.

The liquid crystal display device of the transverse electric field mode, such as the IPS mode and FFS mode, includes a pixel electrode and a counter-electrode which are formed on an array substrate, and liquid crystal molecules are switched by a transverse electric field that is generated between the pixel electrode and the counter-electrode and is substantially parallel to the major surface of the array substrate. In addition, polarizer plates, which are disposed such that their axes of polarization intersect at right angles, are disposed on the outer surfaces of the array substrate and the counter-substrate. By this disposition of the polarizer plates, for example, at a time of non-application of voltage, a black screen is displayed, and with the application of a voltage corresponding to a video signal to the pixel electrode, the light transmittance (modulation ratio) is varied.

In this liquid crystal display device, if the counter-substrate is electrified with, e.g. static electricity from outside, an unwanted vertical electric field is produced between the array substrate and the counter-substrate. If such a vertical electric field is produced, a defect occurs in the alignment of liquid crystal molecules, leading to degradation in display quality, such as a decrease in transmittance.

In order to suppress the influence due to the electrification of the counter-substrate, there is disclosed a technique of forming a light-transmissive, electrically conductive film on an image display-side surface of the counter-substrate (see Jpn. Pat. Appln. KOKAI Publication No. 2005-77590).

In recent years, there has been a demand for the decrease in thickness of the liquid crystal display panel, and, in many cases, the surface of the substrate is polished. However, if the shield electrode is disposed on the image display side of the counter-substrate, such a problem arises that it becomes difficult to polish the surface of the substrate.

In addition, with the disposition of the shield electrode on the counter-substrate, the shield electrode and the pixel electrode are opposed via a liquid crystal layer. Hence, if a potential difference occurs between the shield electrode and the pixel electrode, an alignment defect of liquid crystal molecules is caused by a vertical electric field that is produced between the shield electrode and the pixel electrode, leading to possible degradation in display quality.

### BRIEF SUMMARY OF THE INVENTION

The present invention has been made in consideration of the above-described problems, and the object of the invention is to provide a liquid crystal display device which can display an image with good display quality, while suppressing the influence due to electrification of a counter-substrate.

According to an aspect of the present invention, there is provided a liquid crystal display device which is configured such that a liquid crystal layer is held between a first substrate and a second substrate, the first substrate comprising: a pixel electrode which is disposed in association with each of pixels in a display region which displays an image; and a counter-electrode which is opposed to the pixel electrode with a distance therebetween, and the second substrate comprising: an insulating substrate; and a shield electrode which is disposed between the liquid crystal layer and the insulating substrate over an entirety of the display region, wherein the liquid crystal layer is formed of a liquid crystal material having a negative dielectric constant anisotropy.

The present invention can provide a liquid crystal display device which can display an image with good display quality, while suppressing the influence due to electrification of a counter-substrate.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a liquid crystal display device of a liquid crystal mode using a transverse electric field according to an embodiment of the present invention;

FIG. 2 is a cross-sectional view that schematically shows the structures of an array substrate and a counter-substrate, which are applied to the liquid crystal display device shown in FIG. 1;

FIG. 3 is a plan view that schematically shows the structures of a pixel electrode and a counter-electrode of one pixel, which are applied to the liquid crystal display device shown in FIG. 1;

FIG. 4 is a cross-sectional view which schematically shows the structures of the array substrate and counter-substrate in the present embodiment;

FIG. 5 is a view showing an alignment direction of a liquid crystal molecule at a time when a transverse electric field is applied to a liquid crystal material having a positive dielectric constant anisotropy;

FIG. 6 is a view showing an alignment direction of a liquid crystal molecule at a time when a vertical electric field is applied to a liquid crystal material having a positive dielectric constant anisotropy;

FIG. 7 is a view showing an alignment direction of a liquid crystal molecule at a time when a transverse electric field is applied to a liquid crystal material having a negative dielectric constant anisotropy; and

FIG. 8 is a view showing an alignment direction of a liquid crystal molecule at a time when a vertical electric field is applied to a liquid crystal material having a negative dielectric constant anisotropy.

### DETAILED DESCRIPTION OF THE INVENTION

A liquid crystal display device according to an embodiment of the present invention will now be described with reference to the accompanying drawings.

An FFS mode liquid crystal display device is described below as an example of a liquid crystal display device of a liquid crystal mode in which a pixel electrode and a counter-electrode are provided on one of substrates and liquid crystal molecules are switched by using a transverse electric field (an electric field substantially parallel to the major surface of the substrate) that is generated between the pixel electrode and the counter-electrode.

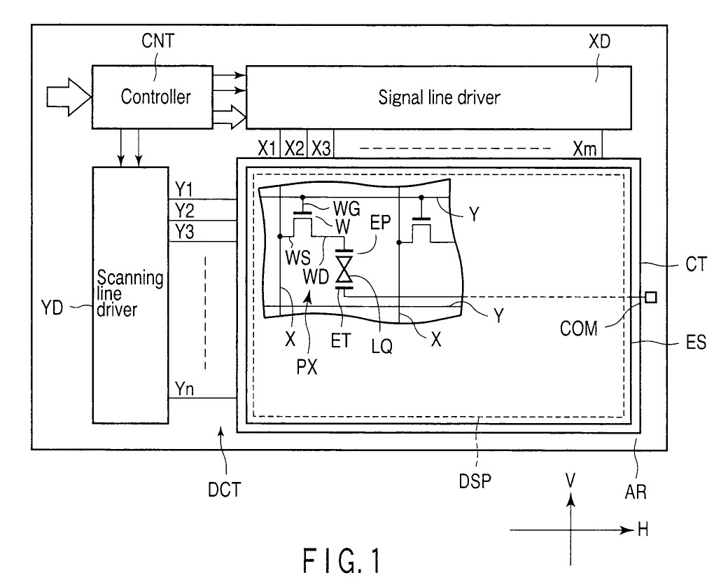

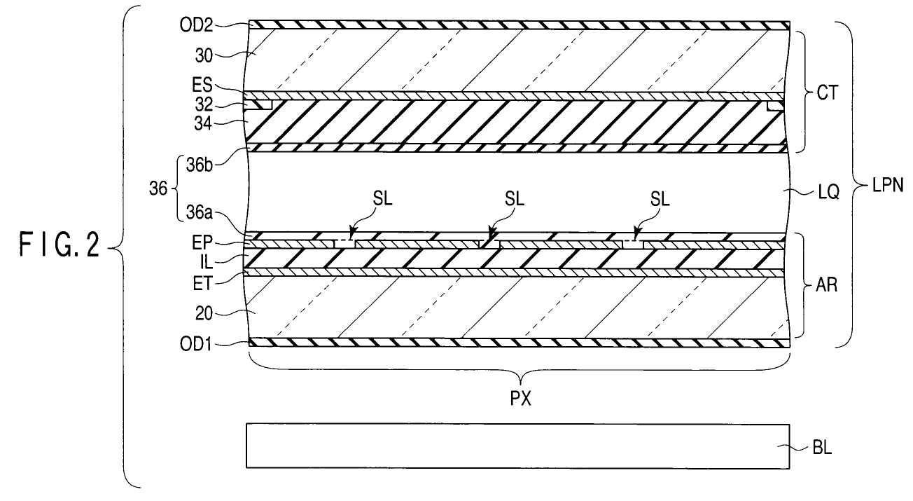

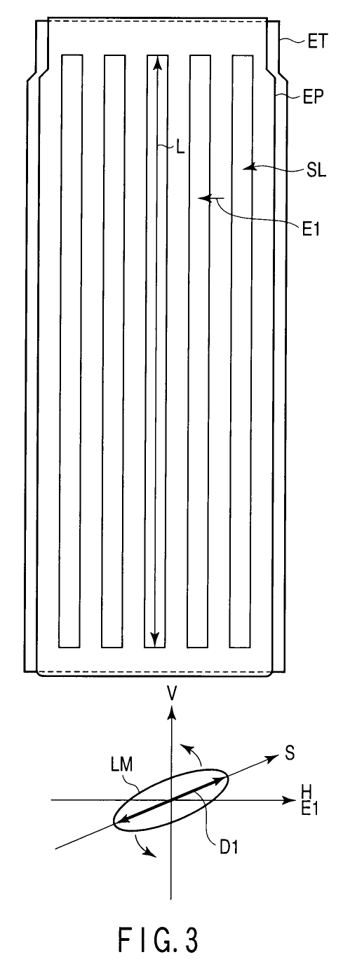

As is shown in FIG. 1, FIG. 2 and FIG. 3, the liquid crystal display device is an active matrix type liquid crystal display device, and includes a liquid crystal display panel LPN. The liquid crystal display panel LPN includes an array substrate (first substrate) AR, a counter-substrate (second substrate) CT which is disposed to be opposed to the array substrate AR, and a liquid crystal layer LQ which is held between the array substrate AR and the counter-substrate CT. This liquid crystal display device includes a display area DSP which displays an image. The display area DSP is composed of a plurality of pixels PX which are arrayed in a matrix of m×n.

The array substrate AR is formed by using an insulating substrate 20 with light transmissivity, such as a glass plate or a quartz plate. Specifically, the array substrate AR includes, in the display area DSP, an (m×n) number of pixel electrodes EP which are disposed in association with the respective pixels PX; an n-number of scanning lines Y (Y1 to Yn) which extend in a row direction H of the pixels PX; an m-number of signal lines X (X1 to Xm) which extend in a column direction V of the pixels PX; an (m×n) number of switching elements W which are disposed in regions including intersections between the scanning lines Y and signal lines X in the respective pixels PX; and a counter-electrode ET which is disposed to be opposed to the pixel electrodes EP with distance therebetween, via an insulation film IL.

The array substrate AR further includes, in a driving circuit region DCT around the display area DSP, at least a part of a scanning line driver YD which is connected to the n-number of scanning lines Y, and at least a part of a signal line driver XD which is connected to the m-number of signal lines X. The scanning line driver YD successively supplies a scanning signal (driving signal) to the n-number of scanning lines Y based on the control by a controller CNT. The signal line driver XD supplies video signals (driving signals) to the m-number of signal lines X based on the control by the controller CNT at a timing when the switching elements W of each row are turned on by the scanning signal. Thereby, the pixel electrodes EP of each row are set at pixel potentials corresponding to the video signals that are supplied via the associated switching elements W.

Each of the switching elements W is composed of, e.g. a thin-film transistor. The semiconductor layer of the switching element W can be formed of, e.g. polysilicon or amorphous silicon. A gate electrode WG of the switching element W is connected to the scanning line Y (or formed integral with the scanning line Y). A source electrode WS of the switching element W is connected to the signal line X (or formed integral with the signal line X) and is put in contact with a source region of the semiconductor layer. A drain electrode WD of the switching element W is connected to the pixel electrode EP (or formed integral with the pixel electrode EP) and is put in contact with a drain region of the semiconductor layer.

The counter-electrode ET is disposed, for example, in an island shape in each of the pixels PX, and is electrically connected to a common wiring line COM to which a common potential is supplied. The counter-electrode ET is formed of a light-transmissive, electrically conductive material such as indium tin oxide (ITO) or indium zinc oxide (IZO). The counter-electrode ET is covered with the insulation film IL.

The pixel electrode EP is disposed on the insulation film IL so as to be opposed to the counter-electrode ET. The pixel electrode EP is provided with a plurality of slits SL which are opposed to the counter-electrode ET. In the example shown in FIG. 3, the slit SL is formed in a rectangular shape. The slit SL is formed such that the long axis L thereof is parallel to the column direction V. The plural slits SL are arranged in the row direction H. The pixel electrode EP is formed of a light-transmissive, electrically conductive material such as ITO or IZO.

That surface of the array substrate AR, which is in contact with the liquid crystal layer LQ, is covered with an alignment film 36a.

On the other hand, the counter-substrate CT is formed by using a light-transmissive, insulating substrate 30, such as a glass plate or a quartz plate. In particular, in a color-display-type liquid crystal display device, as shown in FIG. 2, the counter-substrate CT includes, on an inner surface of the insulating substrate 30 (i.e. a surface opposed to the liquid crystal layer LQ), a black matrix 32 which divides the pixels PX, and a color filter layer 34 which is disposed in each pixel PX which is surrounded by the black matrix 32. In addition, the counter-substrate CT may be configured to include an overcoat layer which is disposed with such a relatively large film thickness as to planarize irregularities on the surface of the color filter layer 34.

The black matrix 32 is disposed on the insulating substrate 30 so as to be opposed to the scanning lines Y and signal lines X and wiring portions of the switching elements W, etc., which are provided on the array substrate AR. The color filter layer 34 is disposed on the insulating substrate 30 and is formed of color resins of different colors, for example, the three primary colors of red, blue and green. The red color resin, blue color resin and green color resin are disposed in association with the red pixel, blue pixel and green pixel, respectively.

That surface of the counter-substrate CT, which is in contact with the liquid crystal layer LQ, is covered with an alignment film 36b. The alignment films 36a and 36b are subjected to rubbing treatment so as to restrict the alignment of liquid crystal molecules LM included in the liquid crystal layer LQ.

When the above-described counter-substrate CT and array substrate AR are disposed such that their alignment films 36a and 36b are opposed to each other, a predetermined gap is created by spacers (not shown) which are disposed therebetween. The liquid crystal layer LQ is formed of a liquid crystal material including liquid crystal molecules LM which are sealed in the gap that is created between the alignment film 36a of the array substrate AR and the alignment film 36b of the counter-substrate CT.

The liquid crystal molecules LM included in the liquid crystal layer LQ are homogeneously aligned by restriction forces that are caused by the alignment film 36a and alignment film 36b. As shown in FIG. 3, the rubbing direction S of the alignment film 36a and alignment film 36b is oblique to the slit SL. The rubbing direction S is set an angle of 45° or less to the row direction H which is perpendicular to the long axis L of the slit SL.

In this liquid crystal display device, at a time of no electric field, that is, when there is no potential difference between the potential of the pixel electrode EP and the potential of the counter-electrode ET (i.e. when no electric field is generated between the pixel electrode EP and the counter-electrode ET), the liquid crystal molecules LM are aligned such that their major-axis direction D1 is parallel to the rubbing direction S.

In addition, the liquid crystal display device includes an optical element OD1 which is provided on one of outer surfaces of the liquid crystal display panel LPN (i.e. that surface of the array substrate AR, which is opposite to the surface thereof that is in contact with the liquid crystal layer LQ), and an optical element OD2 which is provided on the other outer surface of the liquid crystal display panel LPN (i.e. that surface of the counter-substrate CT, which is opposite to the surface thereof that is in contact with the liquid crystal layer LQ). Each of the optical elements OD1 and OD2 includes a polarizer plate, and, for example, a normally black mode, in which the transmittance of the liquid crystal panel LPN decreases to a minimum (i.e. a black screen is displayed) at the time of no electric field, is realized.

Further, the liquid crystal display device includes a backlight unit BL which is disposed on the array substrate AR side of the liquid crystal display panel LPN.

In this liquid crystal display device, when a potential difference is produced between the potential of the pixel electrode EP and the potential of the counter-electrode ET (i.e. at a time of voltage application, when a voltage of a potential different from the potential of the counter-electrode ET is applied to the pixel electrode EP), a transverse electric field (fringe electric field) E1 is generated between the pixel electrode EP and the counter-electrode ET.

The transverse electric field E1 is generated in a direction perpendicular to the long axis L of the slit SL via the slit SL. At this time, the liquid crystal molecule LM is driven such that its major-axis direction D1 is oriented from the rubbing direction S. If the major-axis direction D1 of the liquid crystal molecule LM varies from the rubbing direction S, the modulation ratio relating to the light passing through the liquid crystal layer LQ varies. Accordingly, part of backlight, which emanates from the backlight unit BL and passes through the liquid crystal display panel LPN, passes through the second optical element OD2, and thus a white screen is displayed. In this manner, the backlight is selectively transmitted through the liquid crystal display panel LPN, and an image is displayed.

In the present embodiment, the counter-substrate CT includes a shield electrode ES which is disposed on the inner surface of the insulating substrate 30 over the entire display region DSP, that is, between the insulating substrate 30 and the liquid crystal layer LQ. The shield electrode ES may be disposed anywhere between the alignment film 36b and the insulating substrate 30. In the example shown in FIG. 2, the shield electrode ES is disposed on the insulating substrate 30 and is covered with the color filter layer 34.

In the example shown in FIG. 1, the shield electrode ES is formed in s substantially rectangular shape corresponding to the substantially rectangular display region DSP, and the size of the shield electrode ES is equal to or greater than the size of the display region DSP. The shield electrode ES is formed of a light-transmissive, electrically conductive material such as ITO or IZO.

As described above, the shield electrode ES shields an electrical element, such as static electricity from an outside environment, which is unnecessary for driving the liquid crystal molecules LM. Thus, even if the counter-substrate CT is electrified, the shield electrode ES can shield an electric field that is caused by the electric charge accumulated in the counter-substrate CT, and can suppress entrance of an unwanted electric field into the liquid crystal layer LQ. In short, the shield electrode ES can suppress an adverse effect upon the driving of liquid crystal molecules LM due to the electrification of the counter-substrate CT.

In recent years, there has been a demand for the decrease in thickness of the liquid crystal display panel LPN, and, in many cases, the surface of the substrate is polished. Since the counter-substrate CT adopts such a structure that the shield electrode ES is disposed on the inner surface of the insulating substrate 30, which is opposed to the liquid crystal layer LQ, the outer surface of the insulating substrate 30 can be polished and the demand for the decrease in thickness can be satisfied.

In the above-described FFS mode, in the case where the liquid crystal layer LQ is composed of the liquid crystal material having a positive dielectric constant anisotropy, the liquid crystal molecule LM included in the liquid crystal material is driven such that its major-axis direction D1 is oriented from the rubbing direction S to a direction parallel to the electric field E.

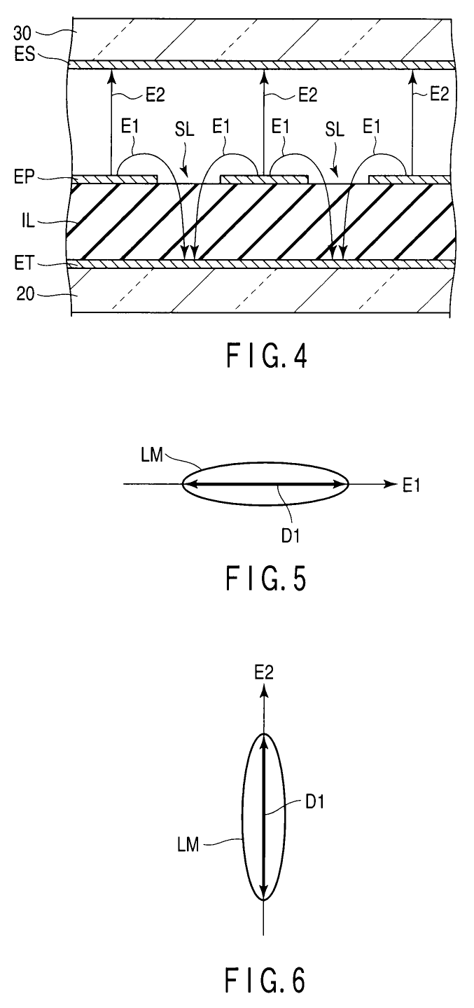

In the case where a transverse electric field E1 is generated between the pixel electrode EP and the counter-electrode ET, as shown in FIG. 4, the liquid crystal molecule LM is aligned such that the major-axis direction D1 of the liquid crystal molecule LM is oriented from the rubbing direction S to a direction parallel to the transverse electric field E1, as shown in FIG. 5. Specifically, the liquid crystal molecule LM is driven substantially in parallel to the major surface of the array substrate AR, and contributes to the modulation of transmittance for displaying an image. FIG. 4 depicts only the main part.

On the other hand, in the case where a potential difference is created between the pixel electrode EP and the shield electrode ES, a vertical electric field E2 is produced, as shown in FIG. 4. At this time, as shown in FIG. 6, the liquid crystal molecule LM is aligned such that the major-axis direction D1 of the liquid crystal molecule LM is oriented from the rubbing direction S to a direction parallel to the vertical electric field E2, as shown in FIG. 6. Specifically, the liquid crystal molecule LM is driven in such a manner as to stand up on the major surface of the array substrate AR. In the mode in which the modulation ratio is controlled by mainly using the transverse electric field E1 and driving the liquid crystal molecule LM in a plane substantially parallel to the major surface of the array substrate AR, the liquid crystal molecule LM standing up on this plane does not contribute to the modulation of transmittance for displaying an image. Consequently, the transmittance lowers.

In the present embodiment, the liquid crystal layer LQ is composed of a liquid crystal material having a negative dielectric constant anisotropy (Δε<0). The liquid crystal molecule LM, which is included in this liquid crystal material, is driven such that its major-axis direction D1 is oriented from the rubbing direction S to the direction perpendicular to the electric field E.

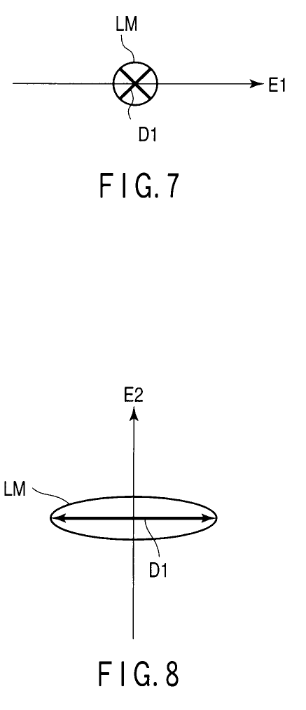

In the case where a transverse electric field E1 is generated between the pixel electrode EP and the counter-electrode ET at a time of image display, as shown in FIG. 4, the liquid crystal molecule LM is aligned such that the major-axis direction D1 of the liquid crystal molecule LM is oriented, as shown in FIG. 7, from the rubbing direction S to a direction perpendicular to the transverse electric field E1 (i.e. a direction normal to the sheet surface of FIG. 7) in the plane substantially parallel to the major surface of the array substrate AR. Specifically, the liquid crystal molecule LM is driven substantially in parallel to the major surface of the array substrate AR, and contributes to the modulation of transmittance for displaying an image.

On the other hand, in the case where a vertical electric field E2 is produced by a potential difference between the pixel electrode EP and the shield electrode ES, the liquid crystal molecule LM is aligned, as shown in FIG. 8, such that the major-axis direction D1 of the liquid crystal molecule LM, which is affected by the vertical electric field E2, is oriented from the rubbing direction S to a direction perpendicular to the vertical electric field E2. This direction that is perpendicular to the vertical electric field E2 is a direction in a plane substantially parallel to the major surface of the array substrate AR. Specifically, the liquid crystal molecule LM is driven substantially in parallel to the major surface of the array substrate AR, without standing up on the major surface of the array substrate AR. Thus, the liquid crystal molecule LM contributes to the modulation of transmittance for displaying an image. Therefore, a decrease in transmittance can be suppressed.

As has been described above, according to the present embodiment, an image with good display quality can be displayed, while the influence due to the electrification of the counter-substrate is suppressed.

Furthermore, in the present embodiment, the shield electrode ES is electrically connected to the counter-electrode ET. Accordingly, the shield electrode ES is set at the same potential as the counter-electrode ET at all times. If a potential difference is created between the potential of the pixel electrode EP and the potential of the counter-electrode ET, a potential difference is also created at the same time between the potential of the pixel electrode EP and the potential of the shield electrode ES.

Specifically, in the case where the pixel electrode EP is set at such a potential as to create a potential difference from the potential of the counter-electrode ET in order to display a white screen, a potential difference is also created at the same time between the pixel electrode EP and the shield electrode ES. Thus, not only the liquid crystal molecule LM which is driven by the transverse electric field E1 that is generated between the pixel electrode EP and the counter-electrode ET, but also the liquid crystal molecule LM which is driven by the vertical electric field E2 that is produced between the pixel electrode EP and the shield electrode ES contributes to the display of the white screen.

As has been described above, the vertical electric field E2 is positively produced between the pixel electrode EP and the shield electrode ES, so as to make the liquid crystal molecule LM, which is driven by the vertical electric field E2, contribute to the image display. Thereby, the transmittance can be improved.

In order to verify the advantageous effect of the present embodiment, the transmittance (%) of the liquid crystal display panel LPN was measured in the present embodiment and a comparative example. The comparative example is a liquid crystal display device which is configured to include a liquid crystal layer LQ that is composed of a liquid crystal material having a positive dielectric constant anisotropy.

At the time of applying a maximum voltage to the pixel electrode EP (i.e. at the time of displaying a white screen), it was confirmed that the transmittance of the liquid crystal display device in the present embodiment was improved by about 25%, compared to the liquid crystal display device of the comparative example. It was thus confirmed that at the time of voltage application, the transmittance can be improved in the liquid crystal display device of the present embodiment than in the liquid crystal display device of the comparative example, and an image with good display quality can be displayed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

In the above-described embodiment, the FFS mode has been described. However, the invention is not limited to the FFS mode and is applicable to other liquid crystal modes which mainly make use of a transverse electric field. For example, the present embodiment is applicable to an IPS mode in which a combtooth-shaped pixel electrode EP and a counter-electrode ET are provided on one of substrates and liquid crystal molecules LM are switched by a transverse electric field that is substantially parallel to the major surface of the array substrate AR.

What is claimed is:

1. A liquid crystal display device which is configured such that a liquid crystal layer is held between a first substrate and a second substrate,
the first substrate comprising:
a pixel electrode which is disposed in association with each of pixels in a display region which displays an image; and
a counter-electrode which is opposed to the pixel electrode with a distance therebetween, and
the second substrate comprising:
an insulating substrate; and
a shield electrode which is disposed between the liquid crystal layer and the insulating substrate over an entirety of the display region,
wherein the liquid crystal layer is formed of a liquid crystal material having a negative dielectric constant anisotropy.

2. The liquid crystal display device according to claim 1, wherein the counter-electrode and the shield electrode are electrically connected.

3. The liquid crystal display device according to claim 1, wherein the pixel electrode includes a plurality of slits, and the pixel electrode is opposed to the counter-electrode with an insulation film being interposed.

4. The liquid crystal display device according to claim 3, wherein the first substrate includes a signal line extending in a column direction of the pixels, and the slits are formed such that major axes thereof are in parallel to the column direction.

5. The liquid crystal display device according to claim 3, further comprising an alignment film which is disposed in contact with the liquid crystal layer and is subjected to such rubbing treatment as to restrict alignment of liquid crystal molecules included in the liquid crystal layer, and
a direction of the rubbing treatment is set at an angle of 45° or less to a direction perpendicular to major axes of the slits.
